(19) United States
(12) Patent Application Publication
(10) Pub. No.: US 2023/0418275 A1
(43) Pub. Date: Dec. 28, 2023

(54) STATE MONITORING SYSTEM

(71) Applicant: NTN CORPORATION, OSAKA (JP)

(72) Inventors: Hiroyuki IWANAGA, Kuwana-shi (JP); Takashi HASEBA, Kuwana-shi (JP)

(73) Assignee: NTN CORPORATION, OSAKA (JP)

(21) Appl. No.: 18/243,685

(22) Filed: Sep. 8, 2023

Related U.S. Application Data
(63) Continuation of application No. PCT/JP2022/008748, filed on Mar. 2, 2022.

(30) Foreign Application Priority Data
Mar. 9, 2021 (JP) 2021-037688

(51) Int. Cl. G05B 23/02; G16Y 40/20; G16Y 40/10

(52) U.S. Cl. CPC G05B 23/0221; G16Y 40/20; G16Y 40/10

(57) ABSTRACT

The condition monitoring system is for monitoring the conditions of a piece of equipment and includes: a sensor configured to be installed to the piece of equipment; a data instrumentation unit configured to receive a sensing signal from the sensor to acquire instrumentation data from the sensing signal under a predefined instrumentation condition; and a data diagnosis unit configured to receive the instrumentation data from the data instrumentation unit and use the instrumentation data to perform a diagnosis process to diagnose the conditions of the piece of equipment. The data diagnosis unit includes an edge application and an industrial IoT platform. The edge application includes a data collection and analysis module, and the data collection and analysis module is configured to calculate a feature for the instrumentation data from the data instrumentation unit and broadcast the feature to the industrial IoT platform.

### CROSS REFERENCE TO THE RELATED APPLICATION

This application is a continuation application, under 35 U.S.C. § 111(a), of international application No. PCT/JP2022/008748, filed Mar. 2, 2022, which is based on and claims Convention priority to Japanese patent application No. 2021-037688, filed Mar. 9, 2021, the entire disclosures of all of which are herein incorporated by reference as a part of this application.

### BACKGROUND OF THE INVENTION

### Field of the Invention

The present invention relates to a state monitoring system or condition monitoring system for monitoring the states or conditions of a piece of equipment.

### Description of Related Art

A condition monitoring system is known, which: uses instrumentation data collected by a sensor installed on a piece of equipment such as industrial equipment; performs, on the instrumentation data, processing such as an effective value calculation and a frequency analysis; and employs the processing results to monitor and assess the conditions of the piece of equipment.

A data system in a production environment is known which uses an Internet-of-things (IoT) technology to make adjustments to various parameters such as a sensor sampling period and/or a sensor scaling value in response to data inputs from a plurality of sensors by taking into account sensor input values and/or network throughputs (Patent Document 1). Further, a system for continuously monitoring a plurality of machines is known, which: acquires, in real-time, a plurality of measured process parameters for an equipment combination including a plurality of pieces of equipment that are operable interactively with each other; determines a derived quantity from the process parameters; and recommends a change to an equipment operation based on the derived quantity or the process parameters (Patent Document 2). Furthermore, a condition monitoring system for monitoring the conditions of a piece of equipment on the basis of the analysis results of instrumentation data collected and analyzed using a sensor installed on the piece of equipment is known, which controls, on the basis of the time required for a vibration analysis and the time necessary for communication, the instrumentation or measuring conditions and calculation parameters for the vibration analysis in such a way that the calculation time is adjusted in a manner that ensures real-timeness (JP Patent Application No. 2020-163942).

### RELATED DOCUMENT

### Patent Document

[Patent Document 1] JP Published Int'l Application No. 2020-530159
[Patent Document 2] JP Patent No. 5295482

### SUMMARY OF THE INVENTION

The real-timeness of condition monitoring is often required for a condition monitoring system for monitoring the conditions of a piece of equipment. For instance, in a production facility, a production site or the like where analysis processing such as a frequency analysis is performed on instrumentation data (e.g., vibration data) taken from a piece of equipment to carry out an equipment diagnosis on the basis of the analysis processing results, the lack of responsiveness in the analysis results can lead to a delay in the detection of an anomaly in the piece of equipment as well as a delayed action to the anomaly. Real-timeness of analysis processing using instrumentation data, a diagnosis process based on the analysis results, or the like is needed in such a situation.

Today, an industrial IoT platform-based system configuration in which the functionality responsible for performing analysis processing using instrumentation data, a diagnosis process based on the analysis results, or the like is exclusively provided on the side of an edge (i.e., “edge” is a term used in the field of an IoT technology or others to refer to a point from which data collected at a device, a device-side network, or given locations in their vicinities are transferred over communication lines and a term of the counterpart of “cloud”) can be adopted to implement real-time processing at a production facility side or the like. Yet, such a data collection and broadcast functionality provided exclusively on the side of an edge in the industrial IoT platform is often designed to handle, for example, data that are sampled with a low sampling frequency (e.g., about a few hertz), such as a temperature and a pressure,—lower than that of vibration acceleration data—, and, in that case, cannot be considered as suitable for collection of vibration acceleration data that are sampled with a high sampling frequency (e.g., tens of thousands of hertz or more). In addition, a data collection software to be incorporated into the industrial IoT platform is typically intended to simply follow the communication protocols used for the side of the piece of production equipment and is not specifically designed to address the type of data collected by sensors located on the side of an edge, the object monitored for conditions, or the anomaly detection method employed.

The present invention aims for overcoming the aforementioned drawbacks and is based on an object of providing a condition monitoring system which allows adjustments to be made on the side of an edge in such a way to ensure the real-timeness of processing.

To achieve the above object, the present invention provides a condition monitoring system for monitoring the conditions of a piece of equipment. The system includes: a sensor configured to be installed to the piece of equipment; a data instrumentation unit configured to receive a sensing signal from the sensor to acquire instrumentation data from the sensing signal under a predefined instrumentation condition; and a data diagnosis unit configured to receive the instrumentation data from the data instrumentation unit and use the instrumentation data to perform a diagnosis process to diagnose the conditions of the piece of equipment. The data diagnosis unit includes an edge application and an IoT platform (e.g., an industrial IoT platform). The edge application includes a data collection and analysis module. The data collection and analysis module is configured to calculate a feature (a feature value) for the instrumentation data from the data instrumentation unit and broadcast the feature to the (industrial) IoT platform.

Note that the sensor in the above configuration may include at least one of a vibration sensor, a temperature sensor, a pressure sensor, a strain sensor, a load sensor, or an acoustic emission (AE) sensor.

In the above configuration, a condition monitoring system according to the present invention can also include a network located, for example, between devices which may implement the (industrial) IoT platform, in addition to the aforementioned data instrumentation unit, data diagnosis unit, and sensor that is located, for example, on the side of an edge. Among them, the data diagnosis unit includes the (industrial) IoT platform and the edge application (including, for example, a function to collect data such as vibration data, an analysis processing function, and a diagnosis function.) The data collection and analysis module included in the edge application is incorporated into the processing between the data instrumentation unit and the (industrial) IoT platform to calculate, in response to a data input including data which are sampled with a high sampling frequency like vibration acceleration data, a feature (a feature value) required in performing diagnosis and broadcast the feature to the (industrial) IoT platform. In this way, the volume of data collected and broadcasted by the (industrial) IoT platform can be significantly reduced. Further, adjustments can be made on the side of an edge in such a way to ensure the real-timeness of processing.

In the above configuration, the edge application may include, in addition to the data collection and analysis module, a data diagnosis module, a supervision and control module, and a data display module. Also, in the above configuration, the data collection and analysis module of the edge application may be configured to calculate the feature as a function of a type of the sensor. Adjustments to parameters or the like are thus implementable on the side of an edge.

In the above configuration, the data collection and analysis module of the edge application may be configured to calculate a single scalar quantity for each sensor per single retrieval. In this way, regardless of the type of a sensor installed and the sampling frequency of the respective sensor used, the volume of data broadcasted to the (industrial) IoT platform can be kept down to a certain level.

In the above configuration, the data collection and analysis module of the edge application may be configured to calculate at least one of an effective value, an overall value, a peak value, a crest factor, a kurtosis value, or a skewness value, when a type of the sensor is a vibration sensor. This allows an accurate diagnosis to be made in a simpler approach.

Also, in the above configuration, the data collection and analysis module of the edge application may be configured to calculate at least one of an effective value, a peak value, a cumulative peak count, or an energy-converted value, when a type of the sensor is an AE sensor. This allows an accurate diagnosis to be made in a simpler approach, when an AE sensor is used.

Any combinations of at least two features disclosed in the claims and/or the specification and/or the drawings should also be construed as encompassed by the present invention. Especially, any combinations of two or more of the claims should also be construed as encompassed by the present invention.

### BRIEF DESCRIPTION OF THE DRAWINGS

The present invention will be more clearly understood from the following description of preferred embodiments made by referring to the accompanying drawings. However, the embodiments and the drawings are given merely for the purpose of illustration and explanation, and should not be used to delimit the scope of the present invention, which scope is to be delimited by the appended claims. In the accompanying drawings, alike symbols indicate alike or corresponding parts throughout the different figures, and:

FIG. 1 shows a block diagram of the configuration of a condition monitoring system, in accordance with an embodiment of the present invention; and

FIG. 2 shows a flowchart that illustrates the operation of the condition monitoring system.

### DESCRIPTION OF EMBODIMENTS

What follows is a more particular description of embodiments of the present invention made with reference to the drawings. Note that the same or corresponding parts are indicated with alike symbols in the figures and will not be discussed again in detail to avoid redundancy.

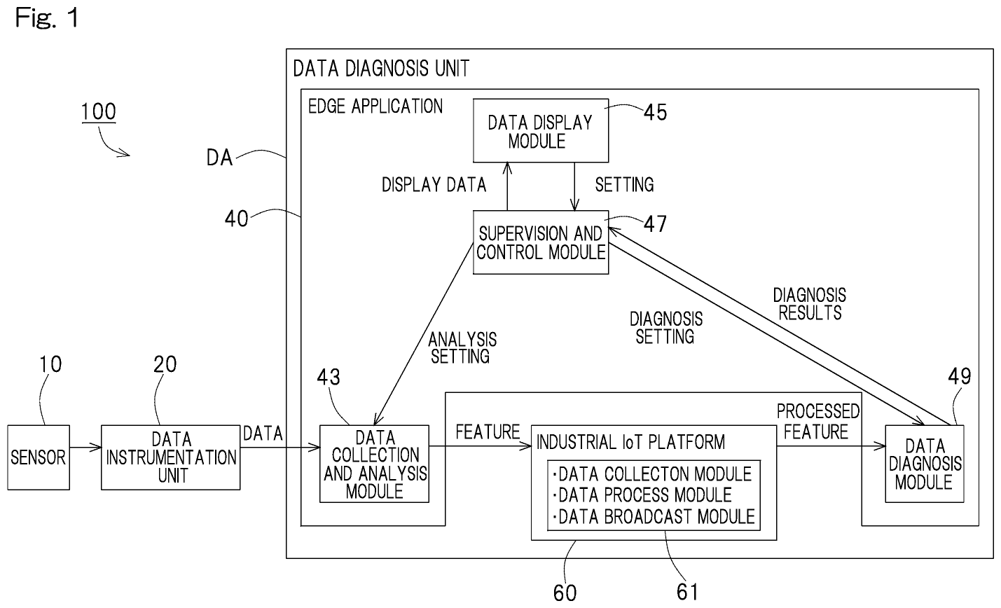

FIG. 1 shows the general configuration of a condition monitoring system in accordance with an embodiment. The condition monitoring system in the instant embodiment is a system for monitoring the conditions of a piece of equipment, includes an IoT platform (an industrial IoT platform) and an edge application operating on the industrial IoT platform, and can be implemented or used by the edge application. The edge application executes collection and analysis of data such as vibration acceleration data as well as feature (feature value) generation, before sending out the same as an input to the industrial IoT platform for an analysis (e.g., a vibration analysis) on the industrial IoT platform. As will be discussed later, the edge application in the instant embodiment includes a data collection and analysis module that carries out the generation and output of a feature, etc., a data diagnosis module that performs diagnosis based on data broadcasted from the industrial IoT platform, and a supervision and control module that supervises and controls these processes in such a manner to enable a real-time diagnosis (i.e., a highly responsive diagnosis) such as a bearing failure or anomaly detection in response to receiving vibration acceleration data sampled with a high sampling frequency (e.g., tens of thousands of hertz or more) as input data.

According to such a configuration of the condition monitoring system in the instant embodiment, a real-time vibration analysis in response to the receipt of vibration acceleration data sampled with a high sampling frequency as an input can be achieved with excellent responsiveness without requiring a change in the industrial IoT platform and by making adjustments that are made possible through simple customizations of the edge application. Further, because a feature (value) required in the diagnosis performed on the edge application is calculated on the side of an edge, the execution of unnecessary processing or an unused volume of files transferred can be eliminated to thereby ensure the real-timeness of processing.

The condition monitoring system 100 illustrated in FIG. 1 includes a sensor a data instrumentation unit 20, and a data diagnosis unit DA (which may hereinafter be referred to simply as a diagnosis unit.)

The sensor 10 can include a variety of types of sensors, such as a vibration sensor installed to a piece of equipment or the like. It should be noted that examples of the sensors included in the sensor 10 are not limited to a vibration sensor but may also include a temperature sensor, a pressure sensor, a strain sensor, a load sensor, and an acoustic emission (AE) sensor. The sensor 10 is operatively connected to the data instrumentation unit 20. In case of the use of a vibration sensor as the sensor 10, an analog signal is passed to the data instrumentation unit 20. In case of the use of a sensor such as a load sensor or an angle sensor which outputs a digital value as the sensor 10, a digital signal is passed to the data instrumentation unit 20. In the remainder of the discussion, it is assumed that the sensor 10 includes a vibration sensor and that a bearing used to rotatably support, for example, a shaft of a rotary machine in industrial equipment is checked for a failure or anomaly (e.g., a vibration detection).

The data instrumentation unit 20 receives a sensing signal (which can be either an analog signal or a digital signal) from the sensor 10. The data instrumentation unit 20 is implemented by, for example, a data logger or a programmable logic controller (PLC) located in a production facility, a production site or the like. The data instrumentation unit 20 acquires instrumentation data from the sensing signal from the sensor, under a predefined instrumentation condition which is defined on an individual basis. The instrumentation condition can include, for example, a retrieval interval, a sampling duration, and a sampling frequency for the instrumentation data.

In one example, the retrieval interval corresponds to an interval between transmissions of the instrumentation data from the data instrumentation unit 20 to the diagnosis unit DA (e.g., in particular, a data collection and analysis module 43—which will be later discussed—of an edge application 40.) It should be noted that the diagnosis unit DA executes analysis processing on, for example, a set of instrumentation data taken within each retrieval interval and uses the results of the analysis processing to perform a diagnosis process. The sampling duration is an actual duration of the sampling by the data instrumentation unit 20 within the retrieval interval and may even equal to the retrieval interval. The sampling frequency is a frequency with which the sensing signal from the sensor 10 (i.e., an analog signal) is sampled. In case of a sensor which outputs a digital signal, the sampling frequency corresponds to a data output rate.

The data diagnosis unit DA is configured with a central processing unit (CPU), a read-only memory (ROM), a random access memory (RAM), etc., (none of which is shown). The CPU loads a program stored in the ROM into the RAM, etc. for execution. The program stored in the ROM contains processing procedures for the data diagnosis unit DA. The data diagnosis unit DA is operated, for example, on a supervision system at a production facility, a production site or the like.

As discussed earlier, the data diagnosis unit DA includes an industrial IoT platform 60 and an edge application 40 that operates in cooperation with the industrial IoT platform 60. Typically, the industrial IoT platform 60 is a software to be installed to an industrial computer incorporated in a supervision system at a production facility or the like. The platform collects data (which can be, for example, feature data from the edge application as will be discussed later) by looking up a predefined monitoring directory in which such data originating from the sensing signal from the sensor 10 are stored. The platform processes the collected data according to a predefined processing condition. The platform broadcasts the processed data to a data diagnosis module—which will be later discussed—of the edge application 40 according to a predefined broadcasting condition.

Typically, just like the industrial IoT platform 60, the edge application 40 is also a software to be installed to an industrial computer. Still, the edge application 40 is an independent software separate from the industrial IoT platform 60 and exchanges files with the industrial IoT platform 60 for data coordination.

FIG. 1 also illustrates a detailed configuration of the data diagnosis unit DA included in the condition monitoring system 100. Turning to FIG. 1, the edge application 40 of the data diagnosis unit DA includes a data collection and analysis module (frontend) 43, a data display module 45, a supervision and control module 47, and a data diagnosis module (backend) 49. It should be noted that the data collection and analysis module 43 may be split into independent data collection module and data analysis module. Moreover, the data display module 45 and the data diagnosis module 49 may be installed to, for example, a separate computer located on a system which is external to and different from the industrial IoT platform 60 or a separate computer located on a network such as a WAN, a LAN, or the Internet.

The data collection and analysis module 43 (or the abovementioned data collection module, for example) receives, from the data instrumentation unit 20, the instrumentation data that are acquired by the data instrumentation unit 20 under an instrumentation condition. Then, the data collection and analysis module 43 (or the abovementioned data analysis module, for example) carries out analysis processing on the instrumentation data. Examples of the analysis processing include a process for calculating an effective value (or a root mean square (RMS)) for the instrumentation data, a process for performing a fast Fourier transform (FFT) on the instrumentation data for a frequency analysis, and a process for calculating an overall value. Note that the input data may pass through a low-pass filter and a high-pass filter before being subjected to the FFT.

Then, the data collection and analysis module 43 (or the abovementioned data analysis module, for example) outputs and stores a result of the analysis processing performed on the sensing signal (or the instrumentation data) (which may hereinafter be referred to, at times, as a “feature” or “feature value”) in a specified location (e.g., the aforementioned monitoring directory) which is monitored by the industrial IoT platform 60. In the event of the use of vibration acceleration data as the instrumentation data, a feature which is in the form of a single scalar quantity such as an effective value, an overall value, a peak value, a crest factor, a kurtosis value, or a skewness value is preferably calculated from the vibration acceleration data acquired per single retrieval. Also, for example, in the event of the use of data from an acoustic emission (AE) sensor as the instrumentation data, a single scalar quantity such as an effective value, a peak value, a peak detection frequency, a cumulative peak count, or an energy-converted value is analogously calculated as a feature. Note that the feature varies as a function of the type of the sensor. In the instant embodiment, an average of features for most recent N samples of the data may be used as a value for evaluation. By thus storing a value with a significantly reduced data volume in the aforementioned monitoring directory on the side of the industrial IoT platform 60 for evaluation, the volume of input data to the industrial IoT platform 60 is reduced down to as little as an inverse of a product of a data sampling frequency (in Hz) and a retrieval interval (in sec).

The industrial IoT platform 60 includes a data collection module, a data process module, and a data broadcast module (collectively indicated as 61). As discussed earlier, the data collection module of the industrial IoT platform 60 collects feature data from the edge application by looking up the aforementioned predefined monitoring directory. The data process module processes the collected feature data according to a predefined processing condition. The data broadcast module broadcasts the same to the data diagnosis module of the edge application 40, only for those collected feature data meeting values within a predefined range of values. Preferably, only a subset of the collected feature data from the edge application 40 which meet a range of valid values under the processing condition are broadcasted to the data diagnosis module 49 of the edge application 40. Such ranges of values may be defined in the industrial IoT platform 60 in a predetermined manner.

The data diagnosis module 49 is operatively connected to the industrial IoT platform 60 to use the processed feature broadcasted from the industrial IoT platform 60 as input data to perform diagnosis. The operation modes of the edge application include “learning mode” and “diagnosis mode” functions. The “learning mode” as an operation mode involves storing and using a specified number of features as counted from the start of the instrumentation, to determine a reference value to be used in the calculation of a threshold value which will be referred to in the diagnosis. When the specified number is reached, a statistical value (e.g., an average value) for those features is set and stored as the reference value. A quantitative measure (e.g., a standard deviation) of the variation among those features obtained during the learning mode is multiplied with a factor and added to the reference value to generate the threshold value. In this context, for example, three of such factors can be provided to produce a set of three threshold values: first, second, and third threshold values. Note that one or more threshold values can be provided, with three being a non-limiting example. By way of example, a value or values that is/are entered and set in the supervision and control module 47, which will be later discussed, is/are used and referred to as the factor or factors, and the reference value and the threshold value are passed to and stored in the supervision and control module 47.

Further, during the “diagnosis mode” as an operation mode, the data diagnosis module 49 performs diagnosis. For instance, the diagnosis is performed according to the following procedures (i) to (iii): (i) an average for most recent N units of the processed data broadcasted from the industrial IoT platform 60 is used as a value for evaluation; (ii) the value for evaluation is compared against different threshold values stored in the supervision and control module 47 to determine a relevant class (or level); and (iii) the relevant class and the value for evaluation are treated as the diagnosis results. The diagnosis results are passed to the supervision and control module 47 and stored in a directory specified by the industrial IoT platform 60. Note that the setting (e.g., the number of data points for the average) for the diagnosis is defined via the supervision and control module 47. When the data diagnosis module 49 is not located in the same physical unit as the industrial IoT platform 60, the abovementioned process takes place over a communication network such as the Internet and a LAN and through an external system.

The supervision and control module 47 manages the supervision and control of the internal components of the edge application 40. It passes display data to the data display module 45 in the edge application 40, while it obtains data that are entered via the data display module 45. The supervision and control module 47 passes the analysis setting entered via the data display module 45 to the data collection and analysis module 43, while it receives and stores the reference value and the threshold value that are fed from the data collection and analysis module 43. The supervision and control module 47 passes the diagnosis setting entered via the data display module 45 to the data diagnosis module 49, while it receives a diagnosis result that is fed from the data diagnosis module 49 and passes the same to the data display module 45.

The data display module 45 which includes an I/O user interface in the instant embodiment is operatively connected to the supervision and control module 47 to receive and display the display data. The data display module 45 further includes an input device and passes information entered in the form of input data to the supervision and control module 47.

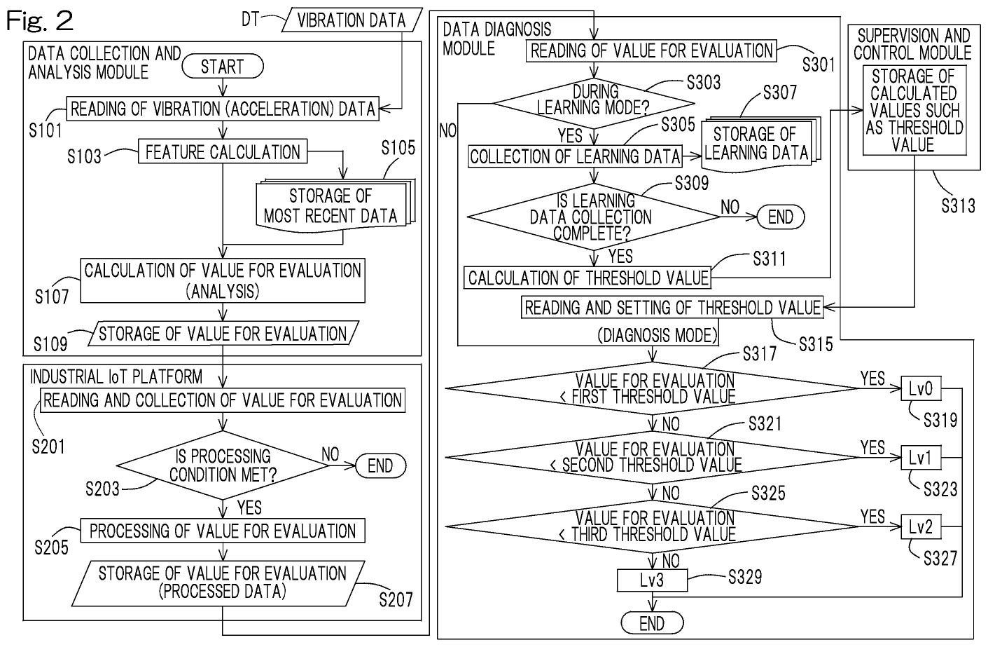

Now, the flow in the diagnosis unit DA up to performing diagnosis will be described with the aid of the flowchart of FIG. 2. Note that, in the chart, the data collection and analysis module 43 performs steps S101 to S109, the industrial IoT platform 60 performs subsequent steps S201 to S207, and the data diagnosis module 49 performs subsequent steps S301 to S329 (except for step S313.) Step S313 is performed by the supervision and control module 47.

Upon the execution of the flow (at START), the data collection and analysis module 43 reads, from the data instrumentation unit 20, data DT which comprise vibration (or vibration acceleration) data in the instant embodiment (at step S101), calculates a feature therefor (at step S103), and stores features for most recent samples of the data (at step S105). Then, during analysis, it calculates a value for evaluation (at step 107) and stores the same (at step S109).

Next, the industrial IoT platform 60 reads and collects, from the aforementioned monitoring directory, a predetermined number of values for evaluation coming from the data collection and analysis module 43 (at step S201) and determines whether they meet a processing condition (at step S203). When they do not meet the processing condition, it ends the process in the flow (at END). When they meet the processing condition, it processes these values for evaluation (at step S205) and stores a processed value for evaluation (or processed data) (at step S207).

Subsequently, the data diagnosis module 49 reads, from the industrial IoT platform 60, the value for evaluation (or the processed data) (at step S301) and determines whether the current mode is a learning mode or not (at step S303). In case of the learning mode, it proceeds to step S305. If not so (or in case of the diagnosis mode), it proceeds to step S317. The current mode is set to either the learning mode or the diagnosis mode, as appropriate, by the supervision and control module 47.

At step S305, it collects and stores such data for learning (or learning data) (at step S307.) At step S309, it determines whether a predetermined number of units of the learning data have been collected or not. When it determines that the specified number of units of the learning data have been collected, it uses the factor and the reference value from the supervision and control module 47 to calculate the threshold value as discussed earlier (at step S311). When it determines that the predetermined number of units of the learning data have not been collected, it ends the process in the flow (at END).

Note that the threshold value, the reference value, etc. which are calculated above are stored in the supervision and control module 47 (at step S313).

Then, at step S315, it reads and sets the threshold value (or first to third threshold values) stored in the supervision and control module 47, and switches to the diagnosis mode to determine the relevant class (or level) during the diagnosis mode and provide and store the diagnosis results as discussed earlier. At step S317, provided that, for example, the third threshold value is higher than the second threshold value and the second threshold values is higher than the first threshold value (i.e., 1st threshold value <2nd threshold value <3rd threshold value), it compares the read value for evaluation (e.g., an average for units of the processed data) against the first threshold value and declares the value for evaluation as level 0 when it is lower than the first threshold value (at step S319) or proceeds to step S321 when the value for evaluation is not lower than the first threshold value (or is at least equal to or greater than the first threshold value.)

At step S321, it compares the read value for evaluation (or the processed data) against the second threshold value and declares the value for evaluation as level 1 when it is lower than the second threshold value (or is at least equal to or greater than the first threshold value but lower than the second threshold value) (at step S323) or proceeds to step S325 when the value for evaluation is not lower than the second threshold value (or is at least equal to or greater than the second threshold value.) At step S325, it compares the read value for evaluation (or the processed data) against the third threshold value and declares the value for evaluation as level 2 when it is lower than the third threshold value (or is at least equal to or greater than the second threshold value but lower than the third threshold value) (at step S327) or declares the value for evaluation as level 3 when it is not lower than the third threshold value (or is at least equal to or greater than the third threshold value) (at step S329), and then ends the process in the flow.

According to the condition monitoring system in the instant embodiment as described, a real-time vibration analysis in response to the receipt of vibration acceleration data sampled with a high sampling frequency (e.g., tens of thousands of hertz or more) as an input can be achieved with excellent responsiveness without requiring a change in the industrial IoT platform and by making adjustments that are made possible through simple customizations of the edge application. Further, because a feature (a feature value) required in the diagnosis performed on the edge application is calculated on the side of an edge, the execution of unnecessary processing or an unused volume of files transferred can be eliminated to thereby ensure the real-timeness of processing.

While preferred embodiments have thus been discussed with reference to the drawings, various additions, modifications, and omissions can be made therein without departing from the principle of the present invention and, therefore, are also encompassed within the scope of the present invention.

### REFERENCE SYMBOLS

10 sensor
20 data instrumentation unit
40 edge application
43 data collection and analysis module
45 data display module
47 supervision and control module
49 data diagnosis module
60 industrial IoT platform
100 condition monitoring system
DA data diagnosis unit

What is claimed is:

1. A condition monitoring system for monitoring conditions of a piece of equipment, the system comprising:
a sensor configured to be installed to the piece of equipment;
a data instrumentation unit configured to receive a sensing signal from the sensor to acquire instrumentation data from the sensing signal under a predefined instrumentation condition; and
a data diagnosis unit configured to receive the instrumentation data from the data instrumentation unit and use the instrumentation data to perform a diagnosis process to diagnose the conditions of the piece of equipment, the data diagnosis unit including an edge application and an industrial IoT platform, the edge application including a data collection and analysis module, and the data collection and analysis module being configured to calculate a feature value for the instrumentation data from the data instrumentation unit and broadcast the feature value to the industrial IoT platform.

2. The condition monitoring system as claimed in claim 1, wherein the sensor includes at least one of a vibration sensor, a temperature sensor, a pressure sensor, a strain sensor, a load sensor, or an AE sensor.

3. The condition monitoring system as claimed in claim 1, wherein the edge application includes, in addition to the data collection and analysis module, a data diagnosis module, a supervision and control module, and a data display module.

4. The condition monitoring system as claimed in claim 1, wherein the data collection and analysis module of the edge application is configured to calculate the feature value as a function of a type of the sensor.

5. The condition monitoring system as claimed in claim 1, wherein the data collection and analysis module of the edge application is configured to calculate a single scalar quantity for each sensor per single retrieval.

6. The condition monitoring system as claimed in claim 1, wherein the data collection and analysis module of the edge application is configured to calculate at least one of an effective value, an overall value, a peak value, a crest factor, a kurtosis value, or a skewness value, when a type of the sensor is a vibration sensor.

7. The condition monitoring system as claimed in claim 2, wherein the data collection and analysis module of the edge application is configured to calculate at least one of an effective value, a peak value, a cumulative peak count, or an energy-converted value, when a type of the sensor is an AE sensor.
